(19) United States
(12) Patent Application Publication
(10) Pub. No.: US 2015/0369585 A1
(43) Pub. Date: Dec. 24, 2015

(54) DEVICE FOR MEASURING THE SURFACE ROUGHNESS OF A SURFACE

(71) Applicant: COMMISSARIAT À L 'ÉNERGIE ATOMIQUE ET AUX ÉNERGIES ALTERNATIVES, Paris (FR)

(72) Inventor: Claude GIRARD, Saint Apollinaire (FR)

(73) Assignee: Commissariat a l'energie atomique et aux energies alternatives, Paris (FR)

(21) Appl. No.: 14/766,034

(22) PCT Filed: Feb. 4, 2014
(86) PCT No.: PCT/EP2014/052097

§ 371 Date: Aug. 5, 2015

(30) Foreign Application Priority Data
Feb. 7, 2013 (FR) 13 51064

(51) Int. Cl. G01B 7/34

(52) U.S. Cl. CPC G01B 7/34

(57) ABSTRACT

A device for measuring surface roughness of an inner surface of a hollow element having a substantially constant inner cross-section. The device includes a probe for making contact with the inner surface of the hollow element, a mechanism straining the probe on the surface, a mechanism measuring movement of the probe, a first mechanism relatively moving the probe, configured to move the probe relative to the inner surface along a path only following the guide line, and a second relative movement mechanism configured to move the probe between at least two positions along the inner cross-section, the straining mechanism configured to strain the probe on the inner surface, regardless of the position of the probe along the inner cross-section. A measuring system can include such a device.

### TECHNICAL FIELD

The invention relates to the field of measuring the surface state of a surface and in particular to determining surface roughness with the aim of qualifying this same surface.

Determining the surface roughness of a surface has become a major problem with regard to cutting edge industries such as aviation, the motor industry or energy production. Indeed, the surface state, and more particularly the surface roughness, determines some of the properties and characteristics of surfaces such as their resistance to corrosion and wear as well as their adhesion and sliding properties.

In the field of energy production, such as the nuclear sector, this issue particularly concerns the gas lines used in energy production facilities. The surface roughness of the inner surface of these lines has a significant effect on pressure drop. Indeed, this surface roughness is one of the main properties that determine the type of gas flow travelling through these lines. Therefore, an inner pipe surface with significant roughness results in turbulent flow and thus experiences high pressure drop. Knowing, and where necessary correcting the surface roughness of gas lines is thus essential.

The invention therefore more particularly concerns a device for measuring the surface roughness of a surface.

### PRIOR ART

The surface roughness of a surface is generally measured using a profilometer-type device. This type of device is classed into two different categories: contact surface profilometers and optical surface profilometers.

Contact surface profilometers generally include a probe designed to be in contact with the surface, a means for straining the probe on the surface, a means for measuring the movement of the probe and a means for moving the probe along the surface. The probe is generally a stylus made from a hard material such as diamond, with a tip diameter having very low dimensions.

The principle of this type of profilometer consists in moving the probe along the surface using the movement means, with a constant strain being exerted by the probe on the surface using the straining means during the movement. During this same movement, the means for measuring the movement of the probe records the movements of the probe along an axis perpendicular to the surface and thus provides a surface profile. Once processed, this profile is used to provide information on the surface state of the surface as well as its surface roughness.

Nonetheless, although this type of profilometer is particularly suitable for characterising flat surfaces such as the surface of a bodywork part or the longitudinal, outer profile of an extended part, their movement means are generally unsuitable for characterising the inner surface of a hollow part.

In order to overcome this disadvantage, prior art and in particular patent application FR 2 972 526 A1, describes profilometers suitable for measuring the surface roughness of a tube having a torus shape. Such profilometers comprise:
a probe designed to be in contact with the inner surface of the tube,
an adjustable straining means for straining the probe on the inner surface, with a substantially constant and adjustable strain, said adjustable straining means being provided by a counterweight,
a means for measuring the movement of the probe, positioned to measure the movement of the probe along an axis substantially perpendicular to the surface,
a means for relatively moving the probe, which is suitable for moving the probe relative to the surface along a path only following a predefined torus guide line.

Nonetheless, although such profilometers are used to measure the surface roughness along a tube guide line with a perfectly controlled strain applied by the probe to the surface, they are not suitable for making such a measurement on a guide line of the tube other than that predefined and for which they were configured. Indeed, in order to correctly compensate the surface curve of the guide line, the relative movement means is only designed to move the probe along a single predefined guide line of the tube. Therefore, any change in guide line requires disassembly of the probe to adapt its assembly with regard to the relative movement means. Moreover, even when disassembling the probe, some guide lines remain inaccessible with such profilometers due to the straining means used, which is subject to gravity. It should also be noted that given that the force applied directly depends on the positioning of the counterweight, without appropriate adjustment, the strain applied between the probe and the surface will not be identical when measuring along two different guide lines.

### DESCRIPTION OF THE INVENTION

The purpose of the invention is to overcome these disadvantages.

One purpose of this invention is therefore to provide a device for measuring the surface roughness of the inner surface of a tube under reproducible measurement conditions along at least two guide lines of the tube, without requiring any disassembly of the probe or adjustment of the straining means of the probe on the inner surface.

For this purpose, the invention relates to a device for measuring the surface roughness of the inner surface of a hollow element extending along a guide line and having a substantially constant inner cross-section transverse to said guide line, comprising:
a probe designed to be in contact with said inner surface,
a straining means for straining the probe on the inner surface, with a substantially constant and adjustable strain,
a means for measuring the movement of the probe, arranged to measure the movement of the probe along an axis substantially perpendicular to the inner surface,
a first means for relatively moving the probe, which is suitable for moving the probe relative to the inner surface along a path only following the guide line,

the device also comprising a second relative movement means, suitable for moving the probe between at least two positions along the inner cross-section, the straining means being suitable for straining the probe on the surface, regardless of the position of the probe along the inner cross-section.

Such a device is used to move the probe along the inner surface of the hollow element in the direction of the guide line for at least two different positions on the inner cross-section, regardless of what these two positions are. Indeed, with such a second relative movement means, the first relative movement means can be implemented to measure the surface roughness along the inner surface of the hollow element in the direction of the guide line for a first position, then the probe can be moved to a second position of the inner cross-section to perform an identical measurement in this second position.

Furthermore, by enabling the force to be controlled both in the first and second positions, the straining means allows for identical force conditions for the surface measurement in the first and second position, thus providing the possibility of comparing such measurements.

The straining means includes at least one magnet and one electromagnet, one being secured to the probe and the other being positioned such that it remains at a constant distance from the guide line when the second relative movement means is not implemented.

Given that such a straining means is not dependent on gravity and given that it is adjustable, it allows for good control over the forces applied on the probe to press it against the inner surface of the hollow element.

The second relative movement means can include a support on which is mounted the probe, the support being mobile in relation to the first relative movement means such that the probe is moved between the at least two positions along the inner cross-section.

Such a support is used to provide a stable base when moving the probe in relation to the inner cross-section of the hollow element.

The device can be designed to measure the surface roughness of a hollow element having an inner cross-section in the shape of a curve, the second relative movement means preferably being designed to move the probe along the inner cross-section.

With such a configuration, the device is used to measure the surface roughness of the inner surface of a hollow element over the entire circumference of its inner surface.

The inner cross-section can be circular, where the second relative movement means is designed to move the probe along a circular path.

The first relative movement means can be designed to move the probe support in relation to the hollow element along the guide line, where the second relative movement means comprises a probe support assembly that is mobile around the guide line.

Such a support assembly that is mobile around the guide line allows for a measurement of the surface roughness along the whole inner cross-section of the hollow element.

One of either the magnet or the electromagnet can be secured to the probe support, the other being secured to the probe.

The probe support, via the supporting function that it provides to the probe during its movement along the inner cross-section, provides a stable base for straining the tip on the inner surface of the hollow element. Therefore, by securing one of either the magnet or the electromagnet to the support, a stable force can be applied during the movement of the probe along a path following the guide line.

The device can be designed to measure the surface roughness of a hollow element extending along a curved guide line, preferably along a section of a circle.

Such a device is used to characterise the inner surface of hollow, curved elements for which the devices in the prior art are not generally suitable.

A probe withdrawal system can be provided for, suitable for moving the probe away from the inner surface when the device is not configured for measurement.

Such a system is used to withdraw the probe when the device is not in the process of characterising the inner surface of the hollow element, for example when moving the probe along the cross-section of the element using the second relative movement means or when installing or removing the hollow element on or from the device.

The movement of the probe by the second relative movement means is indexed according to at least two positions of the probe in relation to the inner cross-section of the hollow element.

When the device is successively used to characterise multiple hollow elements, such indexing of the movement enables comparisons to be made with the measurements produced at exact positions with regard to the cross-section of each of the hollow elements, these positions being indexed.

The invention also relates to a measuring system comprising:
a device for measuring surface roughness, and
a device control electronic assembly,

The device being a device according to the invention.

Such a measurement system allows for the at least partial automation of the use of the device according to the invention.

The electronic system can comprise an electronic controller under computer control and a computer.

### BRIEF DESCRIPTION OF THE FIGURES

This invention will be better understood after reading the following description of embodiments, which is intended for purposes of illustration only and is not intended to limit the scope of the invention, and with reference to the accompanying figures, wherein:

FIG. 1 schematically illustrates a device for measuring surface roughness during its implementation,

FIG. 2 illustrates a close-up view of the measurement head support and of the measurement head of the device illustrated in FIG. 2,

FIG. 3 illustrates a close-up, three-dimensional view of a device according to a first embodiment of the invention,

FIG. 4 illustrates a cross-sectional, three-dimensional view of the device illustrated in FIG. 4,

FIG. 5 illustrates an overview of a measuring system comprising a device illustrated in FIGS. 3 and 4,

FIG. 6 illustrates a probe equipping a device according to a second embodiment,

FIG. 7 illustrates the operating principle of the probe illustrated in FIG. 6.

Identical, similar or equivalent parts of the different figures carry the same numerical references in order to ease the passage from one figure to another.

The different parts shown in the figures are not necessarily displayed according to a uniform scale in order to make the figures easier to read.

The different possibilities (alternatives and embodiments) must be understood as not being exclusive with regard to each other and can be combined together.

### DETAILED DESCRIPTION OF THE SPECIFIC EMBODIMENTS

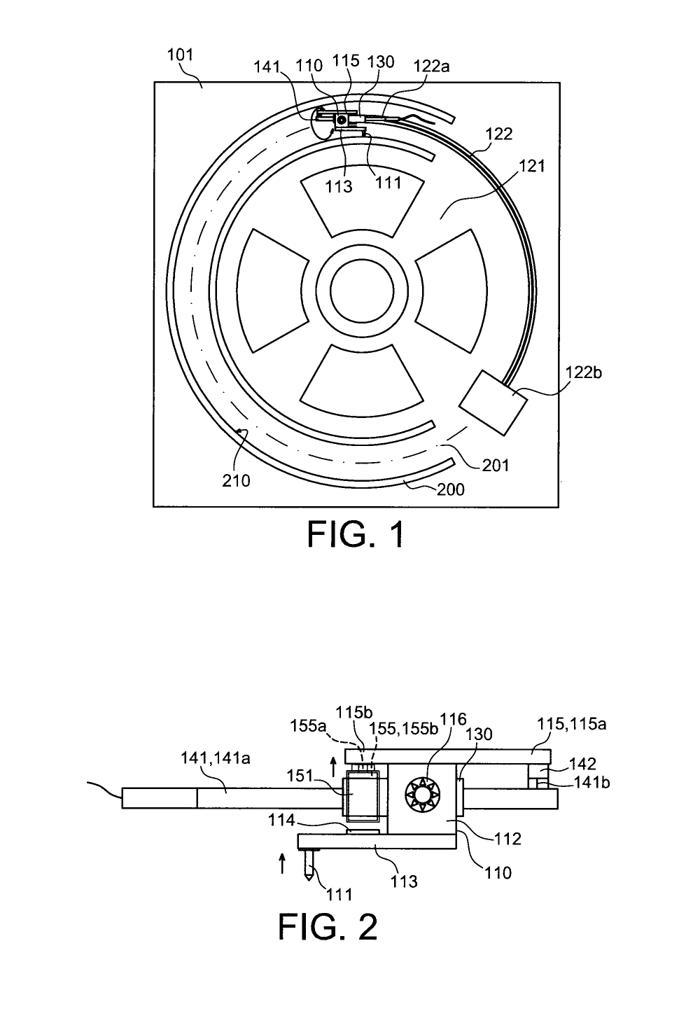

FIG. 1 schematically illustrates a device 100 for measuring the surface roughness of the inner surface 210 of a tube 200 having the general shape of a torus portion.

Such a tube 200 forms a hollow element extending along a guide line 201 in the shape of a circle portion. The tube 200 comprises a curved inner cross-section, circular in shape. In the application particularly targeted by the invention, the guide line 201 represents a circle portion with a diameter between 30 cm and 1 m for an inner cross-section having a diameter between 3 and 30 cm.

Hereinabove and in the remainder of this document, it is understood by curved inner cross-section that the curve of the inner cross-section does not have any discontinuity such as an angle, which could limit the movement of a probe along said cross-section.

As illustrated in FIGS. 1 and 2, such a device 100 comprises:
a base 101,
a plate 121 supporting the tube 200 and mounted such that it pivots on the base 101,
an arm 122 extending along a curved line, the curve of which is substantially identical to that of the guide line 201, the arm 122 comprising a first and second end 122a, 122b and being positioned such that its first end 122a is inserted into the tube 200 on pivoting of the plate 121,
a probe support 141 mounted such that it pivots on the first end 122a of the arm 122 around an axis substantially tangent to the guide line 201,
a measurement head 110 mounted on said support 141, said head comprising a probe 111 strained along the inner surface 210 of the tube 200 to measure the surface roughness of the inner surface 210 of the tube 200.

The base 101 acts as a support for the rest of the device 100. The base 101 in particular comprises a motorisation system, not illustrated, for the controlled pivoting of the plate 121. The motorisation system is preferably indexed to allow for monitoring of the movements of the plate 121, and therefore of the tube 200, when measuring the surface roughness of the inner surface 210 of the tube 200.

The plate 121 supports the tube 200 and, via its assembly pivoting on the base, allows for the movement of the tube 200 in relation to the arm, and therefore of the head 110 which is mounted on the first end 122a of the latter. The plate 121 comprises a holding system, not illustrated, such as links or a support surface, designed to maintain the tube 200 when the latter is installed on the plate 121. The holding system is preferably designed to limit the movements of the tube 200 during its movements linked to the surface roughness measurement of the inner surface 210.

The arm 122 is used to support the head 110 when the tube 200 is moved by the plate in order to allow the head 110 to be inserted into said tube 200. For this purpose, the arm 122 extends along the guide line 201 of the tube such that the arm is inserted into the tube along the path of the guide line 201 when the plate 121 is pivoted. The arm 122 comprises a cross-section with low dimensions in relation to the diameter of the tube 200. In order for the arm 122 to be maintained on the base 101 without this maintenance interfering with the movement of the tube 200, the arm 122 is mounted on the support at its second end 121a.

According to the configuration illustrated in FIG. 1, the arm 122 also acts as a guide for the power and control cables for the head 110, not illustrated herein. Such a configuration is used to reduce the risks of the cables hindering the movement of the tube 200 when measuring the surface roughness of the inner surface 210 of the tube 200. According to one particularly advantageous possibility, not illustrated herein, of this configuration, the arm 122 can be hollow such that it allows for the passage of the power and control cables.

The plate 121, its motorised assembly pivoting on the base 101 and the arm form a first means for relatively moving the probe 111, which is suitable for moving the probe 111 relative to the inner surface 210 of the tube 200 along a path only following the guide line 201. In this embodiment, this relative movement means is positioned to be able to move the tube 200 in relation to the probe 111 such that when the tube 200 is moved, the probe 111 travels over the inner surface 210 of the tube 200.

The head support 130, schematically illustrated in FIG. 2, is mounted such that it pivots on the arm 122 around an axis substantially tangent to the guide line 201 so as to make the head 110 pivot around said axis. Such a movement of the head 110 around the axis substantially tangent to the guide line, when the probe 111 is strained against the inner surface of the tube 210, enables the probe to be moved along the cross-section of the tube 200.

The pivoting assembly of the head support 130 on the arm 122 is preferably motorised such as to allow for the head support 130 to move in an automated manner, even if the latter cannot be accessed by the operator of the device 100, for example when the tube 200 is in a position wherein the head support 150 is housed inside the tube 200.

The head support and its assembly pivoting around the first end 122a of the arm 122 form a second relative movement means designed for the relative movement of the measurement head, and therefore of the probe, in relation to the inner surface 210 of the tube 200 between at least two positions along its inner cross-section. In the configuration illustrated in FIG. 1, the head support and its assembly pivoting around the first end 122a of the arm 122 form a second relative movement means designed for the relative movement of the measurement head 110, and therefore of the probe 111, along the inner cross-section of the tube 200.

According to one advantageous possibility of the invention, the movement of the head support 130 in relation to the arm 122 is indexed for multiple positions of the head support 130, to allow for reproducibility with regard to the positions of the surface roughness measurements along the cross-section. Therefore, with such indexation, the surface roughness measurements on the positions indexed can be compared between two different tubes. The device can, according to this possibility, comprise four indexed positions distributed at equal distances from each other in relation to the cross-section of the tube 200.

As illustrated in FIG. 2, the head support 130 comprises:
an optical sensor 141 for measuring the movement of the probe 111, positioned to measure the movement of the probe 111 along an axis substantially perpendicular to the inner surface 210,
an electromagnet 151 designed to interact with a magnet 114 secured to the probe 111 to strain the probe 111 on the inner surface 210 of the tube 200,
an actuator designed to withdraw the probe from the inner surface of the tube 200 when the device 100 is not configured to characterise the inner surface 210 of the tube, for example when the probe 111 is moved along the inner cross-section of the tube 200.

The optical sensor 141 is a confocal movement measurement sensor according to a principle identical to that presented in FIG. 1 of the patent application FR 2 972 526 A1. The sensor 141 as a substantially longitudinal sensor body 141a. The sensor body 141a is positioned along the pivot axis of the head support.

The sensor 141 is a radial-type confocal measurement sensor, i.e. it has an optical measurement axis perpendicular to the sensor body 141a, and therefore perpendicular to the lever at the pivot axis of the head support 130. The optical axis 141b of the optical sensor 141 is positioned such that the light radiation produced by the optical sensor 141 is reflected by a reflective surface 142 which is secured to the probe 111 during movement, to measure the movements of the surface 142, and therefore of the probe 111, in relation to the optical sensor 140 and of the head support 130.

The actuator 155 is an electromagnetic actuator comprising an actuating rod 155a moved using a second electromagnet 155b between a position wherein the probe 111 enters into contact with the inner surface 210 of the tube 200 and a position wherein the probe 111 is withdrawn from the inner surface 210 of the tube 200. The second electromagnet 155b is secured to the head support 130, the rod 155a being positioned in relation to the second electromagnet 155b such that the latter engages with the measurement head 110 to withdraw the probe 111.

The measurement head 110 is mounted on the head support 130 pivoting around an axis substantially perpendicular to the pivot axis of the head support 130 and to a line passing through the point of contact between the probe 111 and the inner surface 210 of the tube 200 and the point corresponding to the intersection between the pivot axis of the head 110 and the guide line 201.

The head 110 comprises:
a central part 112 by which the head 110 is mounted to pivot on the head support,
a first lever 113 secured to the central part 112,
a probe 111 mounted on the first lever 113 at an end of the first lever 113 opposite the central part 112,
a magnet 114 mounted on the first lever 113 facing the first electromagnet 151 such that the actuation of the first electromagnet induces a force on the magnet 114 which moves the first lever 113 relative to the first electromagnet,
a second lever 115 secured to the central part 112 and substantially parallel to the first lever 113,
the reflective surface 142 secured to the second lever 115, said reflective surface 142 being positioned on the second lever 115 facing the optical sensor 141.

The central part 112 is mounted to pivot on the head support 130 by means of two ball bearings. Therefore, the head 110 is free to pivot in relation to the pivot axis.

The first lever 113 extends in a longitudinal direction from the central part 112 towards the arm 122.

The probe 111 is mounted at the end of the first lever facing the inner surface 210 of the tube 200. Therefore, the probe is free to pivot with regard to the head support 130. In this manner, the probe can freely move in relation to the head support 130 in a direction substantially perpendicular to the inner surface 220 of the tube 200.

The probe 110 can take the form of a tip made from a hard material, such as diamond, tungsten carbide or silicon carbide. The tip, generally conical in shape, has a curvature radius as low as possible. For applications involving measuring the surface roughness of the inner surface 210 of a tube 200, a tip radius of approximately 2 μm is preferred.

The magnet 114 is mounted on the first lever 113 facing the first electromagnet 151. Therefore, the implementation of the first electromagnet 151 generates a force between the electromagnet and the magnet which can, when adapted, pivot the head 110 and strain the probe 110 on the inner surface 210 of the tube 200. This force can be significantly greater than that of the force of gravity applied to the probe 111. Therefore, the magnet 114 and the electromagnet 151 form a straining means suitable for straining the probe 111 on the inner surface 210, regardless of the position of the probe 111 along the inner cross-section 210, the strain applied to the probe 111 not being dependent on gravity.

The second lever 115 extends, by a portion 115a, referred to as long, from the central part 112 mainly in the direction opposite that of the first lever 113. The second lever 115 also comprises a portion 115b, referred to as short, which extends in the same direction as that of the first lever 113. The short portion 115b is designed to provide a resting surface for the rod 155a of the actuator 155. Therefore, actuation of the actuator 155 results in moving the rod 155a resting against the short portion 115b of the second lever 115 to pivot the measurement head 110 and withdraw the probe 111 from the inner surface 210 of the tube 200.

Therefore, the second lever 115 and the actuator 155 together form a probe withdrawal system, suitable for moving the probe 111 away from the inner surface 210 when the device 100 is not configured for measurement.

The long portion 115a of the second lever 115 supports the reflective surface 142 which is therefore secured to the former. Therefore, the reflective surface 142 is secured in movement of the probe 111 and the measurement measuring the movement of the reflective surface 142 by the sensor 141 enables the movement of the probe 111 to be measured.

The sensor 141 and the reflective surface 142 form a means for measuring the movement of the probe 111, positioned to measure the movement of the probe 111 along an axis substantially perpendicular to the inner surface 210.

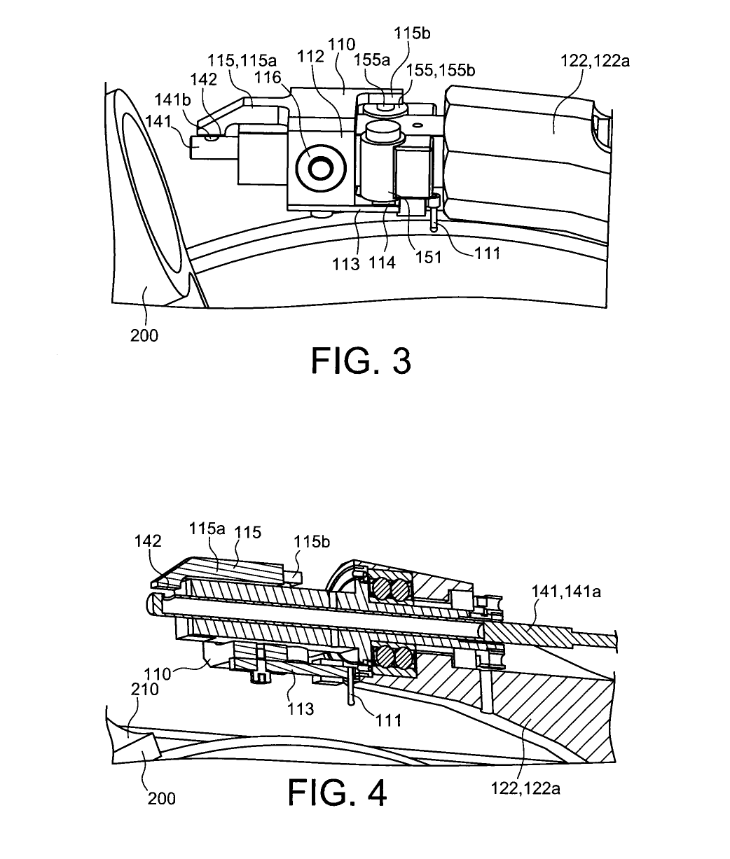

FIGS. 3 and 4 illustrate the head support and the measurement head according to a practical implementation of the invention. In particular, in this practical implementation of the invention, the head support 130 is partially introduced into the first end 122a of the arm 122. In this manner, the head support is mounted in rotation by means of a ball bearing and a motor which are housed in the first end 122a of the arm 122.

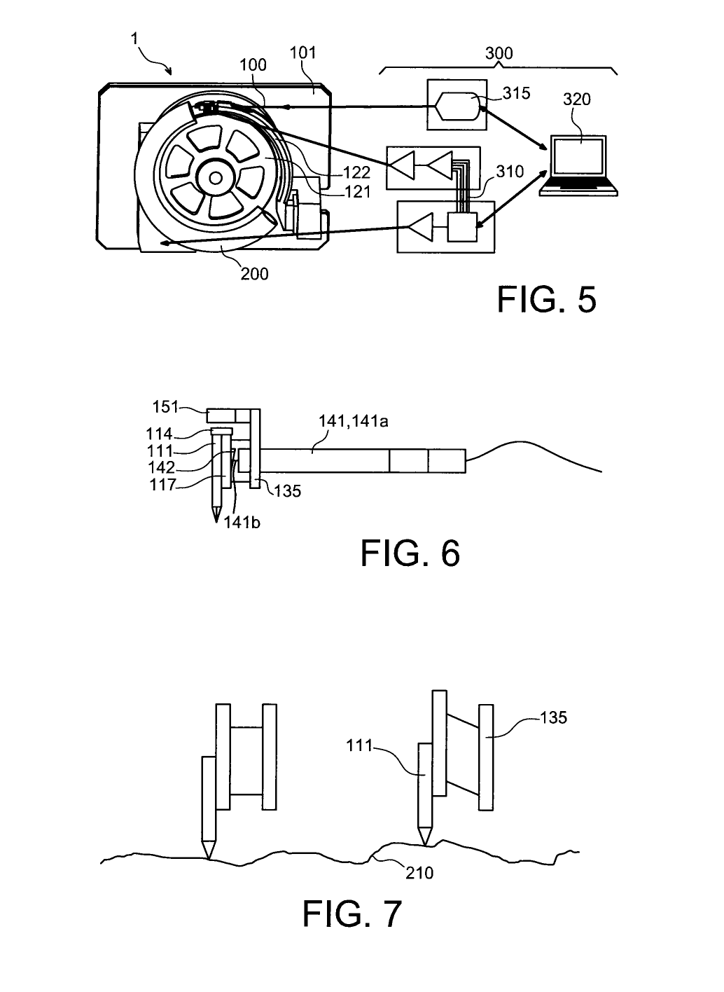

The device, regardless of whether it complies with the practical implementation or not, is, as illustrated in FIG. 5, preferably implemented by means of an electronic controller 310 and a computer 320.

The electronic controller 310 is designed to control the power supply to the plate 121 and head support 130 movement motors and to the first and second electromagnets 151, 155b so as to control the relative movement of the probe 111 in relation to the inner surface 210 of the tube 200 and the strain applied to the probe 111. The electronic controller 310 is itself connected to the computer.

The sensor 141 is connected to the computer 320 via an acquisition electronic assembly 315. Using appropriate software, the computer 320 is therefore able to control the relative movement of the probe 111 in relation to the inner surface 210 of the tube 200 and to measure the movements of the probe 111 along an axis perpendicular to the inner surface 210 of the tube 200.

The computer 320, electronic controller 310 and acquisition electronic assembly 315 form a control electronic assembly 300 of the device 100. The group comprised from the device 100 and the electronic assembly 300 form a measurement system 1.

Such a surface roughness measuring device can be implemented using a method containing the following steps:

a) installation of the tube 200 on the device such that the probe 111 can move relative to the tube 200.

b) application of a strain on the probe 111 using the magnet 114 and the electromagnet 151 to strain the probe 111 on the inner surface of the tube,

c) relative movement of the probe on the inner surface 210 of the tube along a path only following the guide line 201 by means of the plate 121, the movement of the probe 111 along an axis substantially perpendicular to the inner surface being recorded by the sensor 141,

d) relative movement of the probe 111 from a first position to a second position along the inner cross-section of the hollow element by the pivoting of the head support,

e) repeat step c)

According to a preferred implementation of the invention, during such a measurement method, in step d) the first and second positions are, along the inner cross-section, distanced from each other by a quarter of the inner perimeter of said inner cross-section, and steps d) and e) are repeated three times where, in step d) the first and second positions are shifted along the cross-section by one quarter of the inner perimeter always in the same direction such that the probe at the end of the method has travelled along 4 guide lines distributed along the inner cross-section.

It is therefore possible to measure the surface roughness along four guide lines at equal distances along the inner cross-section.

FIG. 6 schematically illustrates a measurement head 110 according to a second embodiment wherein the head 110 is mounted on the head support 130 using a deformable parallelogram 135.

The measurement head 110 according to this second embodiment comprises:
a probe support 117 mounted on the head support 130 by means of the deformable parallelogram 135, the probe support 117 extending along a direction substantially perpendicular to the inner surface 210 of the tube 200,
the probe 111, which is mounted along the probe support 117 facing the inner surface 210 of the tube 200,
a magnet 114 equipping the ends of the probe 111 and the probe support 117 located opposite the inner surface 210 of the tube 200,
the reflective surface 142, which is inclined in relation to the longitudinal axis of the probe 111, such that a movement of the probe 111 modifies the distance between the reflective surface 142 and the sensor 141.

All of the aforementioned directions or positions relative to the inner surface 210 of the tube 200, such as the position of the probe 111 facing the inner surface 210, mentioned hereinabove and before and after this paragraph, are understood as being in relation to the inner surface 210 of the tube 200 at the level of contact between the probe 111 and said inner surface 210.

According to this configuration, the optical axis 141b of the sensor 141 is directed towards the reflective surface along a direction substantially perpendicular to the longitudinal axis of the probe 111 support, i.e. substantially parallel to the tangent of the inner surface 210 of the tube 200.

With such a parallelogram 135, the probe 111 is capable, as illustrated in FIG. 7, of moving in a direction perpendicular to the inner surface 210 of the tube 200. A single electromagnet 151 positioned facing the magnet 114, depending on its polarisation, allows for either the straining of the probe 111 on the inner surface 210 of the tube 200, or for the withdrawal of the probe 111 from said inner surface 210.

In all embodiments described hereinbelow, the device includes a plate mounted such that it pivots, to support the tube, this pivoting of the plate forming the first relative movement means. Without leaving the scope of the invention, the probe may also be mounted such that it is moved by the first relative movement means, the tube being mounted such that it is secured on the device during the measurement. For example, the arm can therefore assume the shape of a rail, the length of which is mounted such that it can move in translation. The arm forming a rail and the probe mounted such that it is capable of moving in translation, form, according to this possibility, the first means for relatively moving the probe, which is suitable for moving the probe relative to the inner surface along a path only following the guide line.

1-11. (canceled)

12. A device for measuring surface roughness of an inner surface of a hollow element extending along a curved guide line and having a substantially constant inner cross-section transverse to the guide line, comprising:
a probe configured to be in contact with the inner surface;
a straining means for straining the probe on the inner surface, with a substantially constant and adjustable strain;
a means for measuring movement of the probe, configured to measure the movement of the probe along an axis substantially perpendicular to the inner surface;
a first means for relatively moving the probe, configured to move the probe relative to the inner surface along a path only following the guide line;
a second relative movement means, configured to move the probe between at least two positions along the inner cross-section, the straining means configured to strain the probe on the inner surface, regardless of a position of the probe along the inner cross-section; and
wherein the straining means includes at least one magnet and one electromagnet, one being secured to the probe and the other being positioned such that it remains at a constant distance from the guide line when the second relative movement means is not implemented.

13. A device according to claim 12, wherein the second relative movement means includes a support on which is mounted the probe, the support being mobile in relation to the first relative movement means such that the probe is moved between the at least two positions along the inner cross-section.

14. A device according to claim 12, configured to measure the surface roughness of a hollow element having an inner cross-section in a shape of a curve, the second relative movement means configured to move the probe along the inner cross-section.

15. A device according to claim 13, wherein the first relative movement means is configured to move the support in relation to the hollow element along the guide line, wherein the second relative movement means comprises a support assembly that is mobile around the guide line.

16. A device according to claim 13, wherein one of either the magnet or the electromagnet is secured to the support, the other being secured to the probe.

17. A device according to claim 12, wherein the movement of the probe by the second relative movement means is indexed according to at least two positions of the probe in relation to the inner cross-section of the hollow element.

18. A device according to claim 12, configured to measure the surface roughness of a hollow element extending along a curved guide line.

19. A device according to claim 12, configured to measure the surface roughness of a hollow element extending along a section of a circle.

20. A device according to claim 12, further comprising a probe withdrawal system configured to move the probe away from the inner surface when the device is not configured for measurement.

21. A measurement system comprising:
a device for measuring surface roughness; and
a device control electronic assembly;
wherein the device is a device according to claim 12.

22. A method for measuring surface roughness of an inner surface of a hollow element extending along a curved guide line and having a substantially constant inner cross-section transverse to the guide line, the method being implemented by a device according to claim 12, the method comprising:
a) installing the hollow element on the device such that the probe can move relative to the hollow element;
b) applying a strain on the probe using the straining means to strain the probe on the inner surface of the hollow element;
c) creating relative movement of the probe on the inner surface along a path only following the guide line by the first relative movement means of the probe, the movement of the probe along an axis substantially perpendicular to the inner surface being recorded by the means for measuring the movement of the probe;
d) creating relative movement of the probe from a first position to a second position along the inner cross-section of the hollow element by the second relative movement means;
e) repeating c).

23. A measurement method according to claim 12, wherein in d) the first and second positions are, along the inner cross-section, distanced from each other by a quarter of the inner perimeter of the inner cross-section, d) and e) being repeated three times wherein, d) the first and second positions are shifted along the cross-section by one quarter of the inner perimeter always in the same direction such that the probe at the end of the method has travelled along guide lines distributed along the inner cross-section.
